(19) United States
(12) Patent Application Publication
(10) Pub. No.: US 2004/0261377 A1
(43) Pub. Date: Dec. 30, 2004

(54) Cooling apparatus for battery of electric vehicle and air duct thereof

(76) Inventor: Ki Taek Sung, Uiwang-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,006

(22) Filed: Dec. 23, 2003

(30) Foreign Application Priority Data
Jun. 30, 2003 (KR) 10-2003-0043786

(51) Int. Cl. B01D 50/00

(52) U.S. Cl. 55/385.3

(57) ABSTRACT

A battery cooling apparatus of an electric vehicle according to this invention comprises a battery tray having a bottom tray in which an air inlet passage is formed and a top tray in which an air outlet passage is formed. Batteries are received between the bottom tray and the top tray. An air duct has an inlet communicating with outside air and an outlet communicating with the air inlet passage of the bottom tray. The outlet of the air duct is preferably opposed to the front wall of the bottom tray. Accordingly, a battery received in the battery tray can be uniformly cooled without temperature difference and degradation caused by dust and moisture.

### CROSS-REFERENCE TO RELATED APPLICATIONS

This application claims priority of Korean Application No. 10-2003-0043786, filed on Jun. 30, 2003.

### FIELD OF THE INVENTION

The present invention relates to a cooling apparatus, and more particularly, a cooling apparatus for a battery of an electric vehicle and an air duct adapted to the cooling apparatus.

### BACKGROUND OF THE INVENTION

Generally, an electric vehicle has a cooling apparatus for prevent a battery from overheating. Typically, a plurality of power supplying batteries are received in a battery tray in a lattice or matrix. The battery tray includes a top tray and a bottom tray with a plurality of air inlet passages formed in the bottom tray in order to supply external air. A plurality of air outlet passages are formed in the top tray in order to guide the exhaust air out after cooling the battery to the outside of the battery tray. A fan may be disposed in the air outlet passage in order to help exhaust air to the outside. The air inlet passage communicates with an air duct, which is disposed in front of the vehicle, and air influx to the air duct supplies cooling air.

However, according to such conventional battery cooling apparatus, the inlet of the air duct is typically formed in a center portion of the battery tray so that supplied air is concentrated in the center portion of the battery tray. Accordingly, the temperature of the battery can vary depending on the location in the battery tray.

In case that the difference between the battery temperatures is increased, each battery has different charge capacity so that the total charge capacity is decreased. Furthermore, if the inlet of the air duct is enlarged in order to solve above described problem, the battery can be damaged by increased moisture and dust contained in the air influx.

### SUMMARY OF THE INVENTION

A battery cooling apparatus of an electric vehicle according to this invention comprises a battery tray having a bottom tray in which an air inlet passage is formed and a top tray in which an air outlet passage is formed so that a battery is received between the bottom tray and the top tray. An air duct inlet communicates with outside air for cooling. The air duct also has an outlet communicating with the air inlet passage of the bottom tray, wherein the outlet of the air duct is opposed to the front wall of the bottom tray.

Preferably, the inlet and the outlet of the air duct transversely extend in order to be same width as the battery tray.

Preferably, a protruding portion, which transversely extends, is formed on the front wall of the bottom tray in order to induce the external air into the inlet of the air duct.

Preferably, the battery cooling apparatus further comprises a fan disposed in outlet passage of the top tray.

Preferably, the battery cooling apparatus further comprises a filter disposed in the inlet of the air duct, wherein a plurality of water drain holes is formed through bottom portion of the air duct.

### BRIEF DESCRIPTION OF THE DRAWINGS

FIG. 1 is a perspective view of an air duct for battery cooling apparatus according to an embodiment of this invention; and

FIG. 2 is a cross sectional view of a battery cooling apparatus according to an embodiment of this invention.

### DETAILED DESCRIPTION OF THE PREFERRED EMBODIMENTS

A preferred embodiment of the present invention will hereinafter be described in detail with reference to the accompanying drawings.

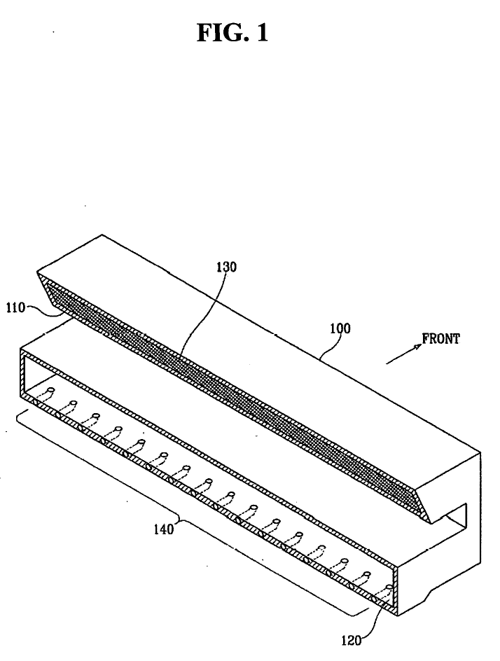

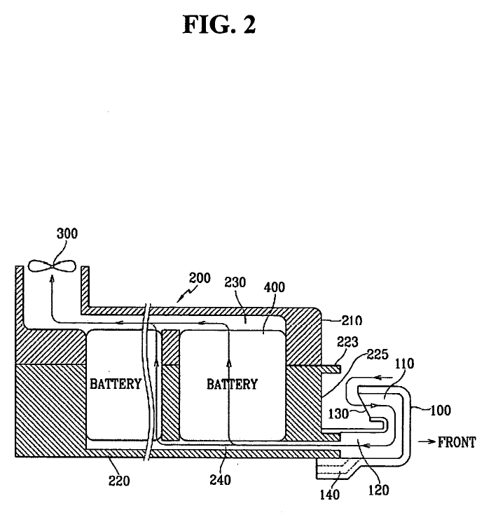

As shown in FIG. 1 and FIG. 2, the air duct 100 is formed in the shape of U and has an inlet 110 and an outlet 120. Both the inlet 110 and the outlet 120 are open to the direction of rear of the vehicle and the outlet of the air duct 120 is connected to the battery tray 200. The inlet 110 and the outlet 120 of the air duct 100 extend transversely in order to be same width of the battery tray 200 so that external air can be supplied to the battery tray 200 at a uniform flow rate with respect to the entire width of the battery tray 200.

The inlet of the air duct 120 is directed to the rear of the vehicle so that dust and moisture contained in the does not flow into the air duct 100 and the battery tray 200. The inlet of the battery tray 100 is provided with a filter 130 to further prevent dust and moisture contained in air from flowing into the air duct 100 and the battery tray 200. Preferably, the filter 130 is formed with a wire screen.

A plurality of water drain holes 140 are formed through bottom portion of the air duct 100. Accordingly, the moisture passing through the filter 130 runs onto the inside wall of the air duct 100 and is changed into water. The water from the moisture flows to the bottom portion of the air duct and is drained through the water drain hole 140.

The outlet of the air duct 100 is connected to the inlet of the bottom tray 240. On the front wall of the bottom tray 220, a protruding portion 230 transversely extends in order to induce the external air into the inlet of the air duct 110.

The protruding portion 230 is placed higher than the inlet of the air duct 220. Accordingly, in case that the electric vehicle proceeds forward, external air is guided by the protruding portion 230 and runs into the front wall of the bottom tray 225 so that the air flow path is changed in order to be directed to the inlet of the air duct 110. Owing to the protruding portion 223, although the inlet of the air duct 110 is directed to backward of the vehicle, the external air can be induced into the air duct.

As shown in FIG. 2, the battery tray 100 has top tray 210 and the bottom tray 220 and a plurality of batteries 400 received between the top tray 210 and the bottom tray 220. A plurality of air inlet passages 240 are formed in the bottom tray 220 for supplying the influx air to the battery 400 and a plurality of air outlet passages 230 is formed in the top tray 210 for exhausting the air passed through the battery 400 to the outside of the battery tray 200.

During the process of air flowing in the battery tray 200, heat transfer occurs between the battery 400 and the air flowing from the air inlet passage 240 to the air outlet passage 230 so that the battery is cooled. Meanwhile, the external air can be supplied to the battery at a uniform flow rate with respect to the entire width of the battery tray 200 so that the battery tray is uniformly cooled without temperature difference.

Preferably, a fan is mounted in the end of the air outlet passage 230 formed in the top tray 210. The fan is operated so as to exhaust the air flow in the battery tray 200 to outside of the battery tray 200 so that the battery 400 received in the battery tray 200 can be cooled more efficiently.

According to the above described battery cooling apparatus and air duct, the battery 400 received in the battery tray 200 can be uniformly cooled without temperature difference so that the entire charge cavity of the battery 400 is not decreased. Furthermore, it is prevented that dust and moisture causing the break down of the battery 400 is flow into the air duct 100 and battery tray 200.

What is claimed is:

1. An air duct for batteries in an electric vehicle, comprising:
an air inlet open to outside the vehicle such that external air may be induced therein;
an outlet communicating with a battery tray receiving a plurality of batteries between a top tray and a bottom tray;
wherein, the inlet is configured to open to a rear of the vehicle so that the inlet is opposed to a front wall of the battery tray.

2. An air duct of claim 1, wherein the inlet and the outlet of the air duct transversely extends with a width substantially the same as a width of the battery tray.

3. An air duct of claim 2, wherein a filter is disposed in the inlet of the air duct.

4. An air duct of claim 3, wherein a plurality of water drain holes is formed through bottom portion of the air duct.

5. A battery cooling apparatus of an electric vehicle, comprising:
a battery tray having a bottom tray in which an air inlet passage is formed and a top tray in which an air outlet passage is formed, said bottom tray top tray being configured and dimensioned to receive at least one battery therebetween; and
an air duct having an inlet communicating with outside air and an outlet communicating with the air inlet passage of the bottom tray;
wherein the outlet of the air duct is opposed to the front wall of the bottom tray.

6. The battery cooling apparatus of claim 5, wherein the inlet and the outlet of the air duct transversely extend with a width substantially the same as a width of the battery tray.

7. The battery cooling apparatus of claim 5, wherein a protruding portion, which transversely extends, is formed on a front wall of the bottom tray in order to induce the external air into the inlet of the air duct.

8. The battery cooling apparatus of claim 5, further comprising a fan disposed in outlet passage of the top tray.

9. The battery cooling apparatus of claim 5, further comprising a filter disposed in the inlet of the air duct, wherein a plurality of water drain holes is formed through bottom portion of the air duct.
